(19) United States
(12) Patent Application Publication
(10) Pub. No.: US 2005/0196257 A1
(43) Pub. Date: Sep. 8, 2005

(54) Device for translocating roadway markers

(75) Inventors: Carl Villeneuve, LeGardeur (CA); Andre Dubois, Brownsburg-Chatham (CA)

Correspondence Address: ROTHWELL, FIGG, ERNST & MANBECK, P.C., 1425 K STREET, N.W., SUITE 800, WASHINGTON, DC, 20005, US

(73) Assignee: Trafic Innovation Inc., St-Eustache (CA)

(21) Appl. No.: 10/792,791

(22) Filed: Mar. 5, 2004

(51) Int. Cl. B60P 1/00

(52) U.S. Cl. 414/434

(57) ABSTRACT

A roadway marker transferring device for a vehicle having a longitudinal axis is provided. The device comprises a support for mounting the device on the vehicle and a transferring member connected to the support. The transferring member comprises a first end and a second end with a transferring section therebetween, the transferring section being at an oblique angle relative to the longitudinal axis of the vehicle. Upon movement of the vehicle, the first end engages the roadway marker at a first position on the roadway, the transferring section then engages and transfers the roadway marker towards the second end of the transferring member wherein the roadway marker is afterwards released at a second position on the roadway.

### FIELD OF THE INVENTION

The invention relates to a vehicle and a device for moving roadway markers between respective first and second positions on the roadway.

### BACKGROUND OF THE INVENTION

Roadway markers are utilized in multiple applications that require a non-permanent direction of the traffic of vehicles on a roadway. For instance, roadway markers are utilized on road construction sites to direct the traffic of vehicles in alternative routes or to safely deflect the traffic from construction work and workers. As well, roadway markers are also employed on multiple-lane roadways to efficiently alter the number of lanes that respectively extend to and from urban areas based on time of day and anticipated traffic patterns.

For example, on a five-lane roadway, roadway markers may be positioned at a respective first position on the roadway such as to allocate three lanes for the flow of traffic into an urban area during morning rush hour, the remaining two lanes being allocated to the flow of traffic out of the urban area. Conversely, during evening rush hour, the roadway markers may be positioned at a respective second position on the roadway such as to allocate three lanes for the flow of traffic out of the urban area and the remaining two lanes to the flow of traffic into the urban area. As a result, the roadway markers have to be moved from their respective first position during the morning rush hour to their respective second position during the evening rush hour.

There is a need in the industry to provide a roadway markers transferring device for a vehicle that allows transfer of the roadway marker between first and second positions on the roadway upon movement of the vehicle.

### SUMMARY OF THE INVENTION

In accordance with a broad aspect, the invention provides a roadway marker transferring device for a vehicle having a longitudinal axis. The device comprises a support for mounting the device on the vehicle and a transferring member connected to the support. The transferring member comprises a first end and a second end with a transferring section therebetween, the transferring section being at an oblique angle relative to the longitudinal axis of the vehicle. Upon movement of the vehicle, the first end engages the roadway marker at a first position on the roadway, the transferring section then engages and transfers the roadway marker towards the second end of the transferring member wherein the roadway marker is afterwards released at a second position on the roadway.

The transferring section may comprise a plurality of rollers for rotating and sliding the roadway marker as the marker is transferred towards the second end of the transferring member. In a specific embodiment, the plurality of rollers are positioned on the transferring section such that at least one roller is in contact with the roadway marker as the marker is transferred towards the second end of the transferring member.

The invention also provides a vehicle comprising the aforesaid roadway marker transferring device.

These and other aspects and features of the present invention will now become apparent to those of ordinary skill in the art upon review of the following description of the embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 is a perspective view of a vehicle equipped with a roadway marker transferring device in accordance with an embodiment of the invention;

FIG. 2 is a top view of the vehicle equipped with the roadway marker transferring device shown in FIG. 1;

FIG. 3 is a perspective view of a central section of a transferring member of a roadway marker transferring device in accordance with an embodiment of the invention;

FIG. 4 is a perspective view of a main left section of a transferring member of a roadway marker transferring device in accordance with an embodiment of the invention;

FIGS. 5 to 9 are perspective views of a plurality of pivotally connected sections of the main left section shown in FIG. 4;

FIG. 10 is a top view of the main left section shown in FIG. 4;

FIG. 11 is a perspective view of a pivot having two separate pins in accordance with an embodiment of the invention;

FIG. 12 is a top view of the main left section shown in FIG. 10 in a second configuration;

FIG. 13 is a perspective view of a support of the roadway marker transferring device in accordance with an embodiment of the invention;

FIG. 14 is a perspective view of a first frame of the support shown in FIG. 13;

FIG. 15 is a top view of the support and transferring member of the roadway marker transferring device in accordance with an embodiment of the invention;

FIG. 16 is a perspective view of a second frame of the support shown in FIG. 13;

FIG. 17 is a top view of a mechanism for folding the transferring member of the roadway marker transferring device in accordance with a particular embodiment of the invention;

FIG. 18 is a front elevational view of the vehicle equipped with the roadway marker transferring device when the roadway marker transferring device is in a compact configuration;

FIG. 19 is a perspective view of the vehicle equipped with the roadway marker transferring device shown in FIG. 18; and

FIG. 20 is a block diagram of a control system for controlling the roadway marker transferring device in accordance with a particular embodiment of the invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF THE EMBODIMENTS

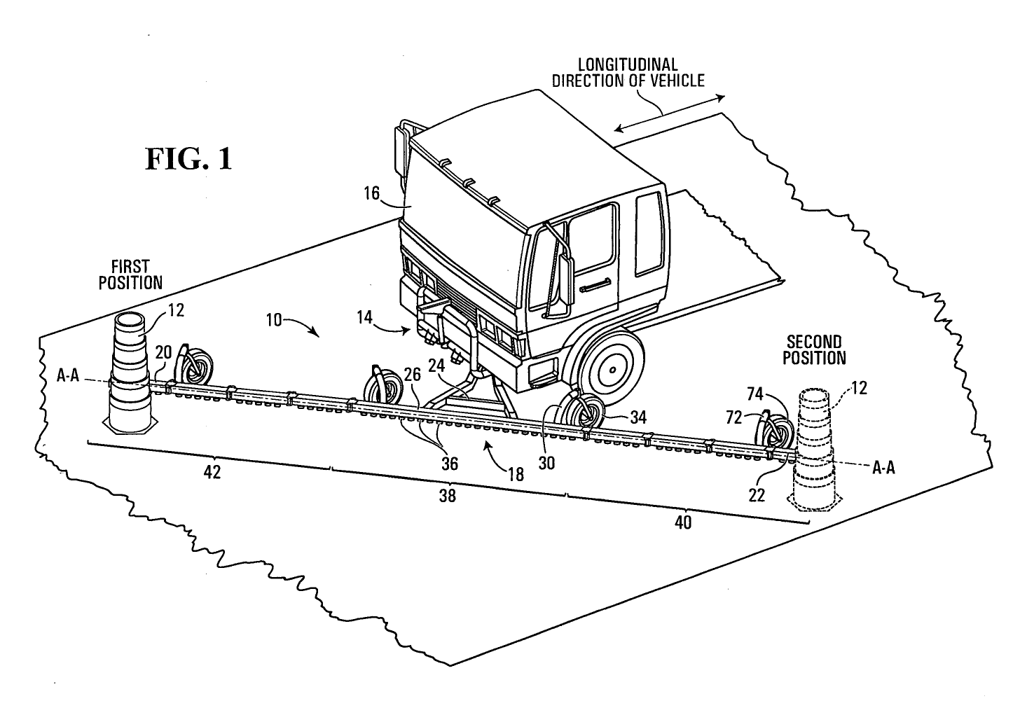

In FIG. 1, a device for transferring a roadway marker 12 from a first position on a roadway to a second position on the roadway is illustrated generally and identified by reference numeral 10. The first position may correspond to the side of the road, or to a first roadway lane, and the second position may correspond to a roadway lane, or a second roadway lane. In fact, it is understood that these first and second positions correspond to two different positions relative to the roadway wherein the traffic is transferred from one stream of traffic to another stream of traffic when the markers are transferred from the first position to the second position.

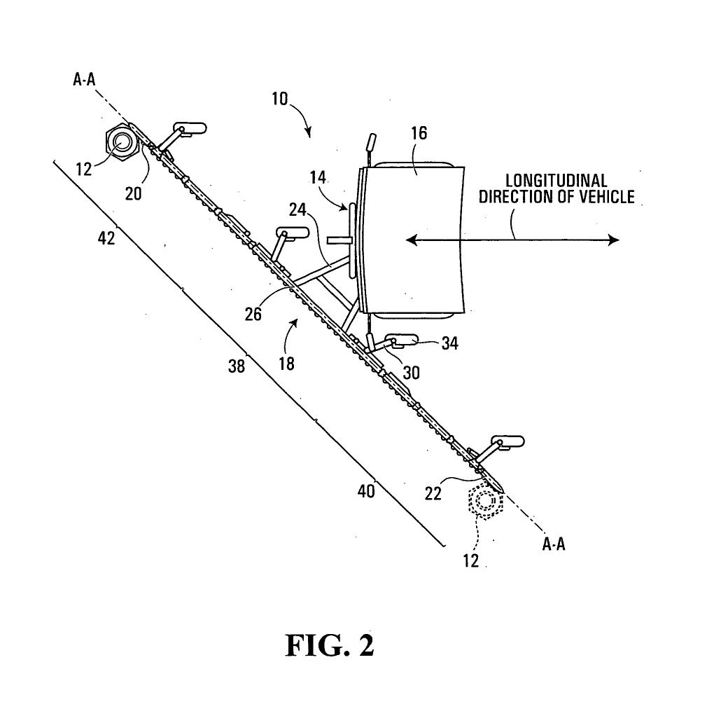

The device comprises a support 14 for mounting the device on a vehicle 16 and a transferring member 18 connected to the support 14. The transferring member 18 has a first end 20 and a second end 22 and a transferring section therebetween. As further described herein below, upon movement of the vehicle 16, the transferring section of the transferring member 18 is oriented such that an imaginary line A-A extending between the first and second ends 20 and 22 of the transferring member is at an oblique angle in relation to the longitudinal axis of the vehicle 16 (as best seen in FIG. 2). As such, the roadway marker 12 at the first position on the roadway is engaged by the first end 20 of the transferring member 18, transferred to the second end 22 of the transferring member 18, and released afterwards therefrom at the second position on the roadway.

The device 10 may also include a mechanism for maintaining the transferring member 18 in a predetermined configuration and, upon impact and subsequent contact with a substantially immovable object, for allowing the transferring member 18 to assume a new configuration suitable to clear the immovable object and subsequently return to the predetermined configuration. In addition, the device 10 may also include another mechanism for folding the transferring member 18 into a compact configuration in a transport mode. As well, the device 10 may also include other mechanisms for controllably pivoting, lowering, and raising the transferring member 18 in relation to the support 14.

It is understood that the vehicle 16 on which the device 10 is mounted is represented as a truck for purposes of illustration only. Accordingly, the device 10 may be adapted to other types of motor vehicles such as automobiles, vans, or construction vehicles without departing from the spirit and scope of the invention. As well, in the present description, an “operation mode” refers to a state wherein the vehicle 16 is in motion (or about to start or stop its motion) and the device 10 is in a configuration that allows the transferring of the roadway markers. In contrast, a “transport mode” refers to a state wherein the vehicle 16 is in motion (or about to start or stop its motion) but the device 10 is in a compact configuration that does not allow the transferring of the roadway markers.

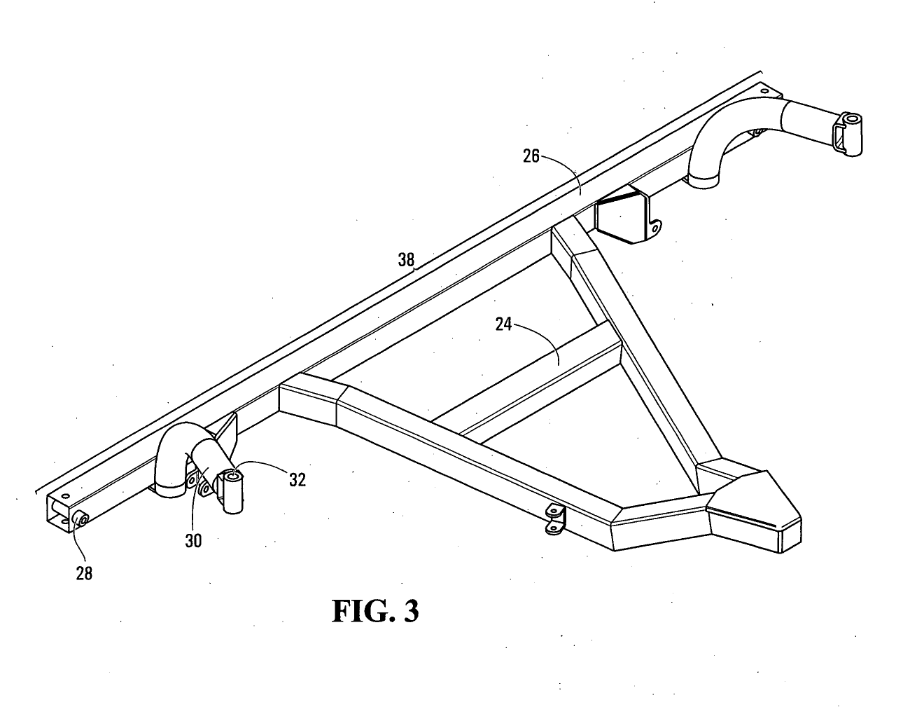

The transferring member 18 may comprise a generally V-shaped truss assembly 24 adapted to be connected to the support 14 and a main member 26 connected to the truss assembly 24 and defining the first and second ends 20 and 22 of the transferring member 18. As can be seen in FIG. 3, on both sides of the V-shaped truss assembly 24, the main member 26 includes a transversely extending pin 28 and a wheel support bracket 30. The wheel support bracket 30 is provided with a pin 32 allowing a wheel assembly 34 (FIG. 1) to pivot about a generally vertical axis of the pin 32. It is understood that various other configurations (such as, for instance, various arrangements and designs of the elements of the truss assembly 24 and main member 26) can be used in building the transferring member 18 without departing from the spirit and scope of the invention.

The transferring member 18 comprises a plurality of spaced rollers 36 adapted to rotate and slide the roadway marker 12 as the marker is transferred between the first and second ends 20, 22 of the transferring member 18. The rotation of the roadway marker 12 caused by the rollers 36 facilitates the displacement of the marker as it contacts the transferring member 18. In fact, due to the presence of the rollers 36, the marker may remain in contact with the roadway when the transferring member 18 transfers the roadway marker towards the second end 22. The spacing between the rollers 36 may be such that there is always at least one roller in contact with the roadway marker 12 as the latter is transferred between the first and second ends 20, 22 of the transferring member 18. In a specific embodiment, it has been found that rollers having an outer diameter of 2.5 inches and a center-to-center spacing of 3.0 inches is adequate for a roadway marker having a diameter of 16 inches at the height of contact between the transferring member 18 and the roadway marker 12.

The main member 26 of the transferring member 18 may also include a plurality of pivotally connected sections. In the embodiment shown in FIG. 1, the main member 26 includes a central section 38, a left arm (or main left section) 40 pivotally connected to the central section 38, and a right arm (or main right section) 42 pivotally connected to the central section 38. Optionally, in this embodiment, the left arm 40 and the right arm 42 respectively include four pivotally connected sections although this is for purposes of example only, as it will be appreciated that the arms 40 and 42 may respectively include any number of pivotally connected sections.

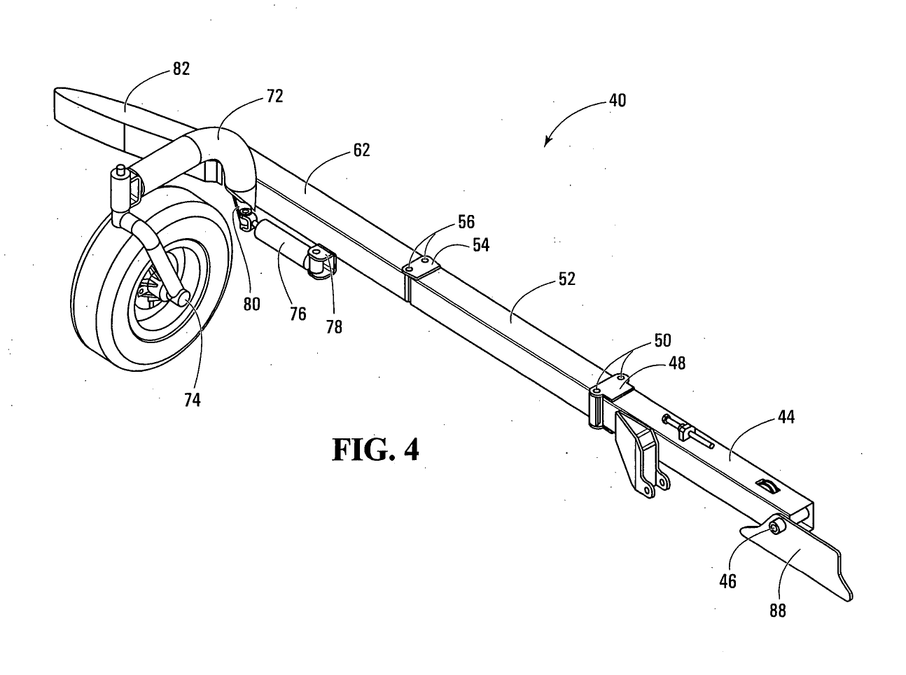

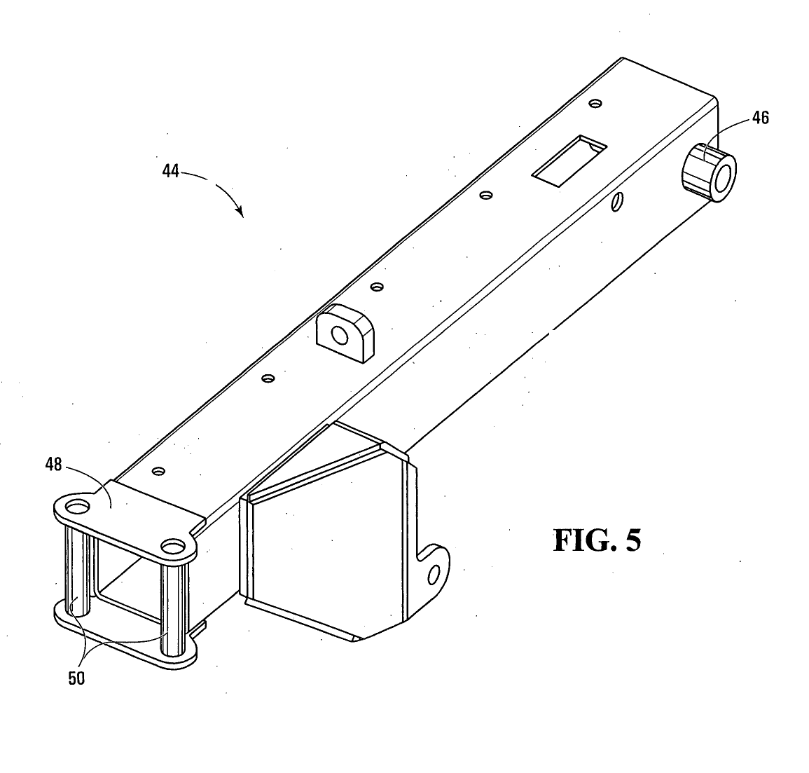

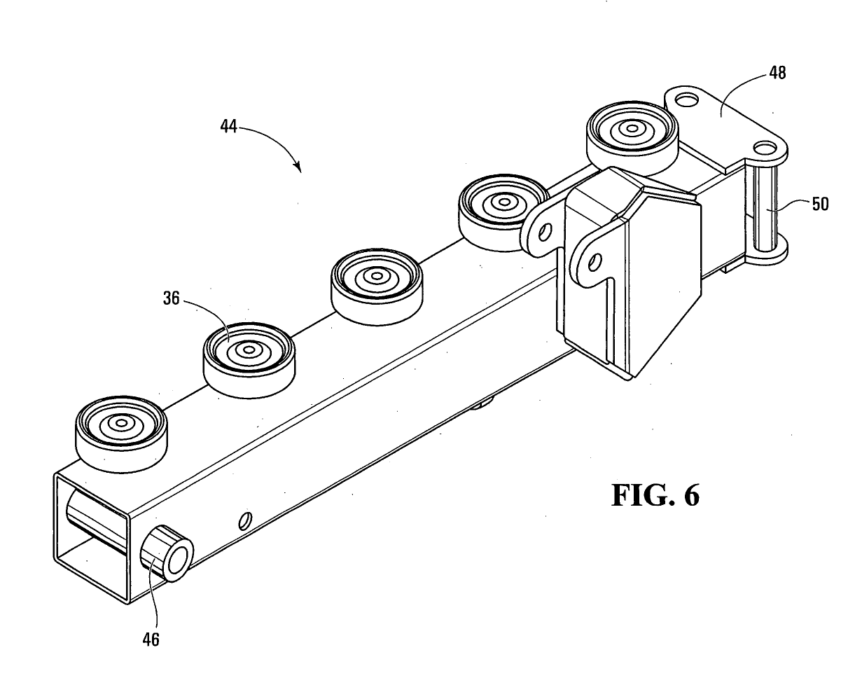

The four pivotally connected sections of the left arm 40 are described in FIGS. 4 to 9. As shown in FIGS. 5 and 6, the fourth leftmost section 44 includes a transversely extending pin 46 at a first end and a pivot bracket 48 having two spaced pins 50 at a second end. The transversely extending pin 46 is used to connect the fourth leftmost section of the left arm 40 to the central section 38 as will be described herein below. Also, as shown in FIG. 6, a plurality of rollers 36 are rotatably mounted to the bottom wall of the fourth leftmost section 44 such that an arc of their respective cylindrical surface extends beyond the front wall of the fourth leftmost section 44. The rollers 36 are thus positioned to rotate the roadway marker 12 thereby facilitating the displacement of the marker 12 as it contacts this section of the transferring member 18.

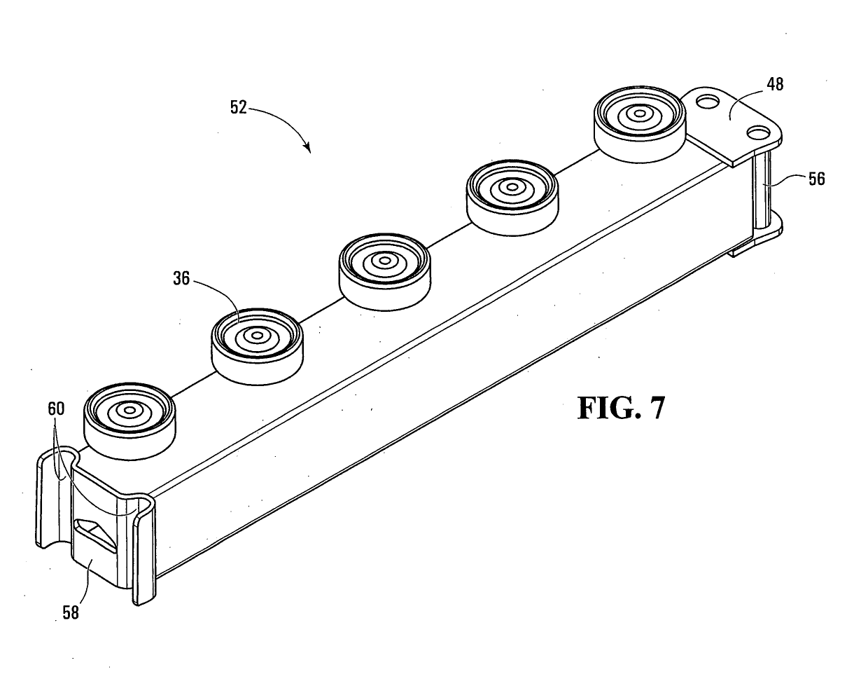

Referring to FIG. 7, the third leftmost section 52 of the left arm 40 includes a pivot bracket 54 having two spaced pins 56 at a first end and a bearing bracket 58 having two spaced cylindrical surfaces 60 at a second end. As described above in connection with the fourth leftmost section 44, a plurality of rollers 36 are rotatably mounted to the bottom wall of the third leftmost section 52 such that an arc of their respective cylindrical surface extends beyond the front wall of the third leftmost section 52.

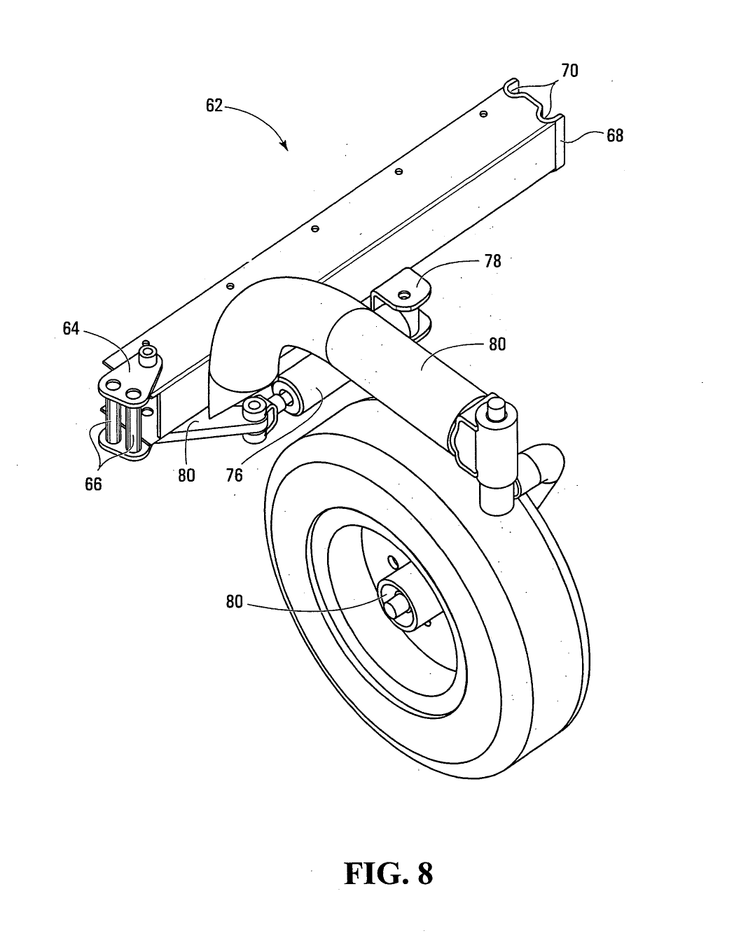

Referring to FIG. 8, the second leftmost section 62 of the left arm 40 includes a pivot bracket 64 having two spaced pins 66 at a first end and a bearing bracket 68 having two spaced cylindrical surfaces 70 at a second end. Similar to that described in relation to the third and fourth leftmost sections 44 and 52, a plurality of rollers 36 (not shown) are rotatably mounted to the bottom wall of the second leftmost section 62 such that an arc of their respective cylindrical surface extends beyond the front wall of the second leftmost section 62. As well, a wheel support bracket 72 is mounted to the rear wall of the second leftmost section 62 and is provided with a pin allowing a wheel assembly 74 to pivot about a generally vertical axis of the pin. In addition, an actuator 76 has a first end pivotally connected to a bracket 78 on the rear wall of the second leftmost section 62 and a second end pivotally connected to a link 80 that pivotally connects to the pivot bracket 64. In the present embodiment, the actuator 76 is a hydraulic cylinder although it will be apparent to those skilled in the art that other types of actuator may be used without departing from the spirit and scope of the invention. As described in further detail below, the hydraulic cylinder 76 is connected via a hydraulic valve and line to a hydraulic panel that is part of a control system of the device 10. As such, the hydraulic cylinder 76 may be actuated to pivot the leftmost section 82 in relation to the second leftmost section 62 within a predetermined range of rotation angles. In a non-limiting example of implementation, the predetermined range of rotation angles is ±15′.

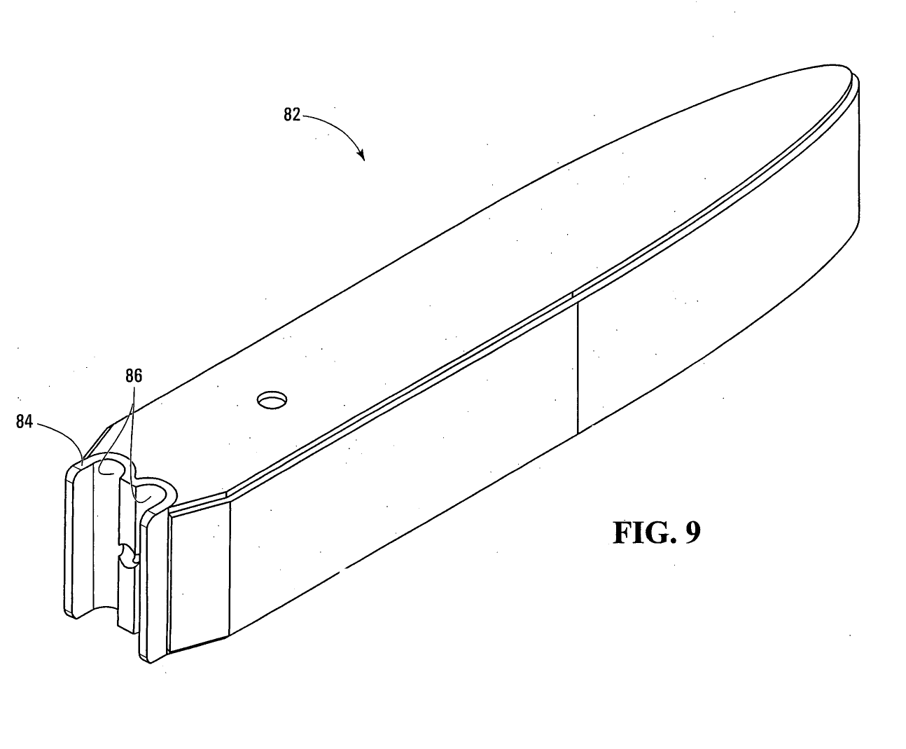

Finally, referring to FIG. 9, the leftmost section 82 includes a bearing bracket 84 having two spaced cylindrical surfaces 86 at one of its ends. Optionally, and similarly to the above three sections, the leftmost section 82 may include a plurality of rollers 36 (not shown) rotatably mounted to its bottom wall such that an arc of each roller's cylindrical surface extends beyond its front wall. As mentioned above, the hydraulic cylinder 76 may be actuated to pivot the leftmost section 82 in relation to the second leftmost section 62 thereby facilitating the engagement of the roadway marker 12 by the transferring member 18.

As can be seen in FIG. 4, the four sections included in the left arm 40 are pivotally connected as follows. The two spaced pins of a first section (for instance, pins 50 of section 44) are aligned with and engaged by the two spaced cylindrical surfaces of a second section (for instance, surfaces 60 of section 52) such that the first and second sections can pivot relative to each other about either of the two pin-cylindrical surface combinations. For its part, the left arm 40 is pivotally connected to the central section 38 by a link 88 adapted to pivotally receive the transversely extending pin 46 of the fourth leftmost section 44 and the transversely extending pin 28 located on the central section 38 (FIG. 3). As further described herein below, the connection between the left arm 40 and the central section 38 of the transferring member 18 allows the left arm 40 to be at least partially folded onto the central section 38 during a transport mode. As well, the connection between the left arm 40 and the central section 38, in combination with the wheel assembly 74, allows for the transferring member 18 to more closely follow the roadway profile as the vehicle moves.

Reverting to FIG. 1, it can be seen that each of the four pivotally connected sections included in the right arm 42 of the transferring member 18 essentially mirror the configuration of their corresponding left arm 40 equivalent sections. The connections between the four sections of the right arm 42 also mirror the connections between the corresponding sections of the left arm 40. The only difference is that the link pivotally connecting the right arm 42 to the central section 38 is adapted to pivotally receive the transversely extending pins of the fourth rightmost section and central section 38, respectively, to allow the right arm 42 to be at least partially folded onto the left arm 40 in the transport mode.

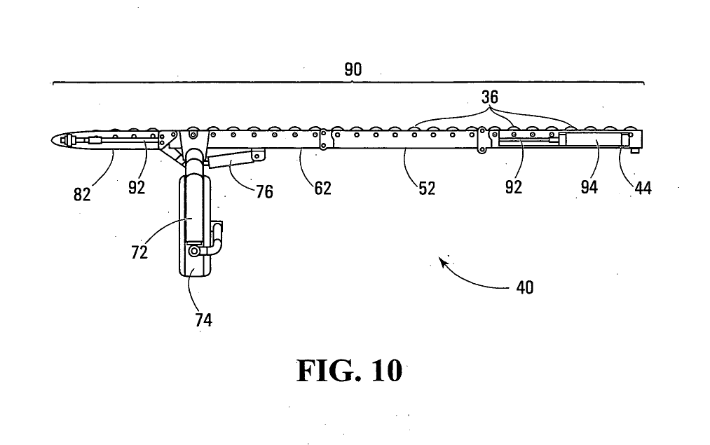

Referring now to FIG. 10, the device 10 for transferring a roadway marker may also include a mechanism 90 for maintaining the pivotally connected sections of the transferring member 18 in a predetermined configuration. In the non-limiting example of implementation shown, the predetermined configuration is a substantially linear alignment of the pivotally connected sections of the transferring member 18. The mechanism 90 is responsive to a predetermined force applied on a first section of the transferring member 18 for allowing the first section to pivot in relation to a second section of the transferring member 18, and for allowing the first section to pivot back to the predetermined configuration when the predetermined force is no longer applied. For example, the force generated by the impact and subsequent contact between the left arm 40 and a substantially immovable object, such as a base of a light post or an automobile wheel, causes for the mechanism 90 to allow the four sections of the left arm 40 to pivot about their respective pivot connections in order to rearrange in a configuration suitable to clear the substantially immovable object. Upon clearance of the substantially immovable object, and thus removal of the applied force, the mechanism 90 allows the four sections of the left arm 40 to pivot back to their original predetermined configuration.

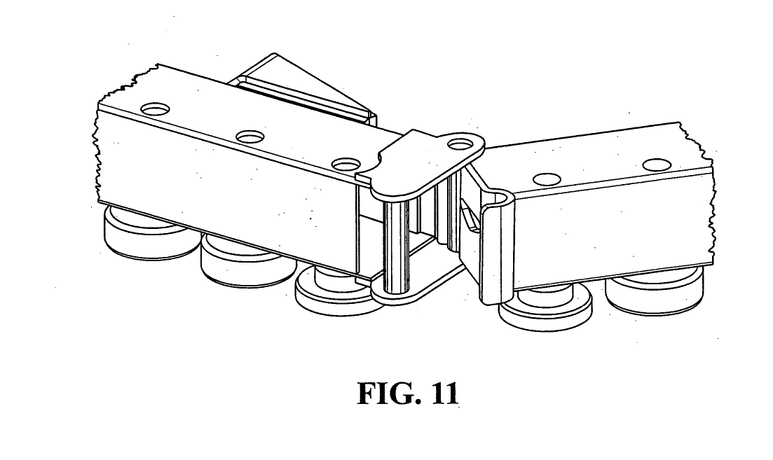

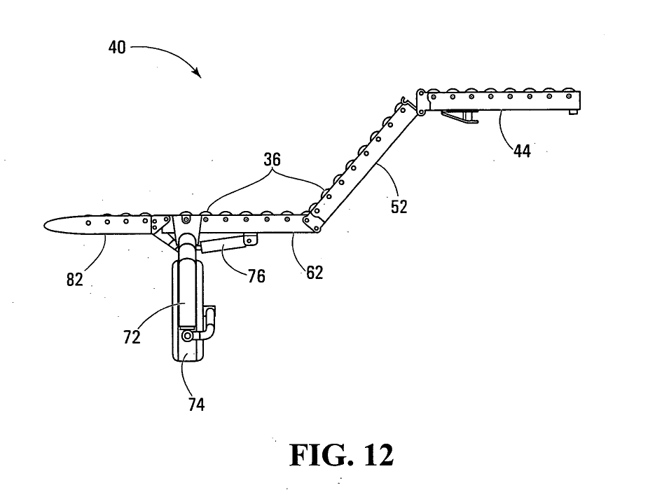

In the embodiment shown in FIG. 10, the mechanism 90 includes a connector (e.g., a chain) 92 linking the four pivotally connected sections of the left arm 40, a hydraulic cylinder 94 mounted on the fourth leftmost section 44 and connected to the connector 92, and a hydraulic accumulator 96 in fluid communication with the hydraulic cylinder 94. The connector 92 maintains the four sections in a predetermined configuration, which is essentially a linear alignment in the embodiment shown. The impact and subsequent contact between one of the four sections and a light post base, automobile wheel, or other substantially immovable object, may cause an applied force that is greater than a predetermined force. The predetermined force may be established at least partially on the basis of the tension in the connector 92 and a calibration of the respective pressures in the hydraulic cylinder 94 and accumulator 96. As seen in FIG. 11, the applied force causes one or more of the four sections to pivot about one of the two spaced pins of the pivot bracket at their respective connections in order to form a new configuration suitable to clear the impacted object and reduce the likelihood of permanently deforming the transferring member 18. As the four sections pivot about each other to form the new configuration, the connector 92 causes a displacement of the hydraulic cylinder 94 connected thereto. In turn, the oil volume displaced by the displacement of the hydraulic cylinder 94 compresses fluid included in the hydraulic accumulator 96. For example, FIG. 12 shows a configuration taken by the four sections of the left arm 40 as a result of an impact and subsequent contact between a light post base and a region near the left end of the second leftmost section 62. As can be seen, the third leftmost section 52 has pivoted about one of the two pins of the pivot bracket connecting it to the fourth leftmost section 44. The third leftmost section 52 has also pivoted about one of the two pins of the pivot bracket connecting it to the second leftmost section 62.

After clearing the substantially immovable object, the applied force is no longer applied and the mechanism 90 allows the four pivotally connected sections to pivot back to their original predetermined configuration. In effect, the compressed fluid in the hydraulic accumulator 96 pushes on the internal piston of the cylinder 94, thereby pulling on the connector 92 which causes for the four pivotally connected sections to pivot back to their original configuration.

It is to be understood that the right arm 42 of the transferring member 18 includes a mechanism identical to the mechanism 90 described above in connection with the left arm 40. Thus, the four sections of the right arm 42 also have the ability to pivot about their respective pivot connections when an impact and subsequent contact between a substantially immovable object and the right arm 42 occurs. Once the impacted object is cleared, the mechanism in the right arm 42 is operative to allow the sections to pivot back to their original configuration.

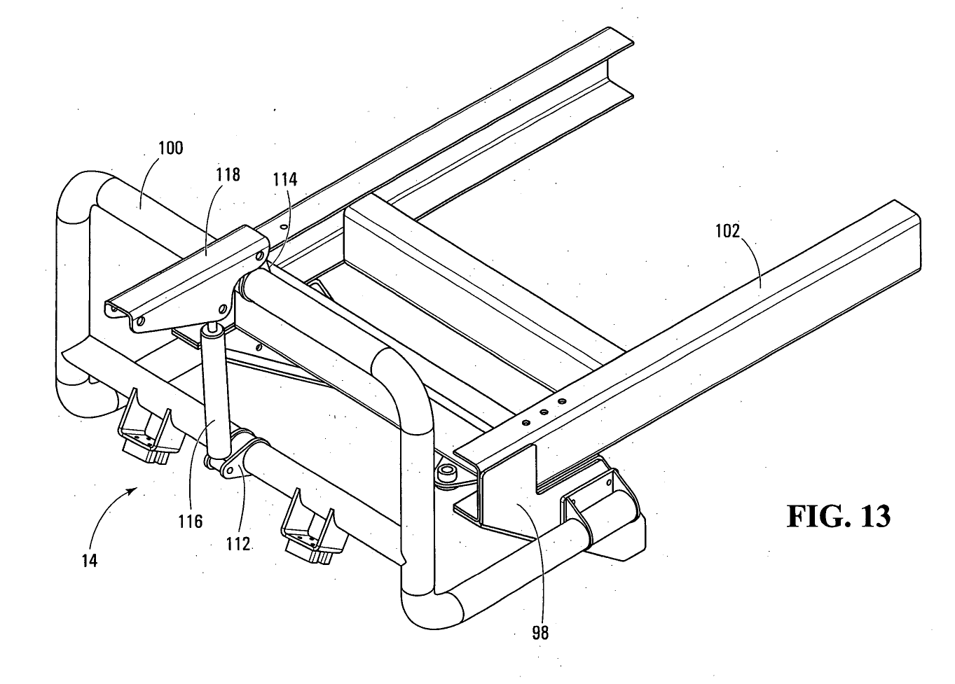

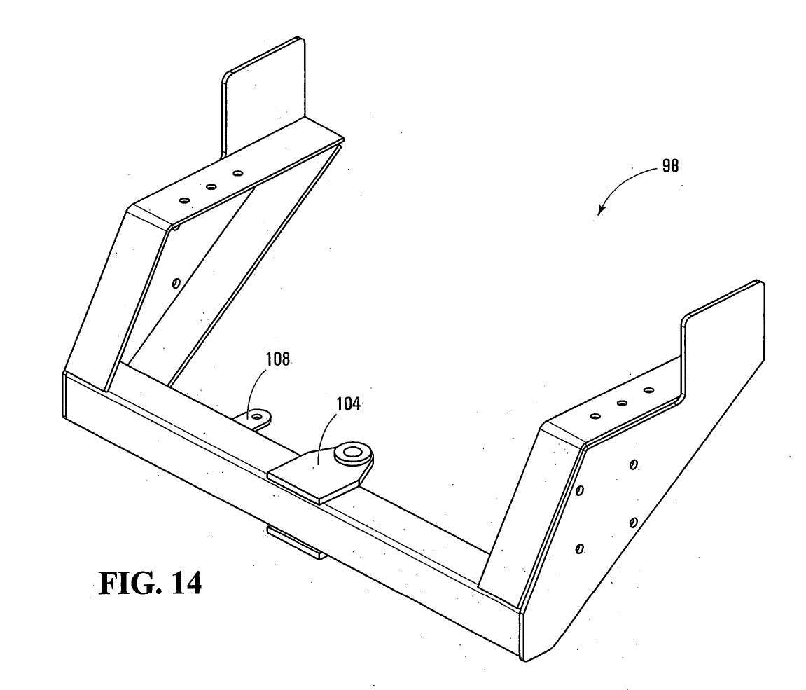

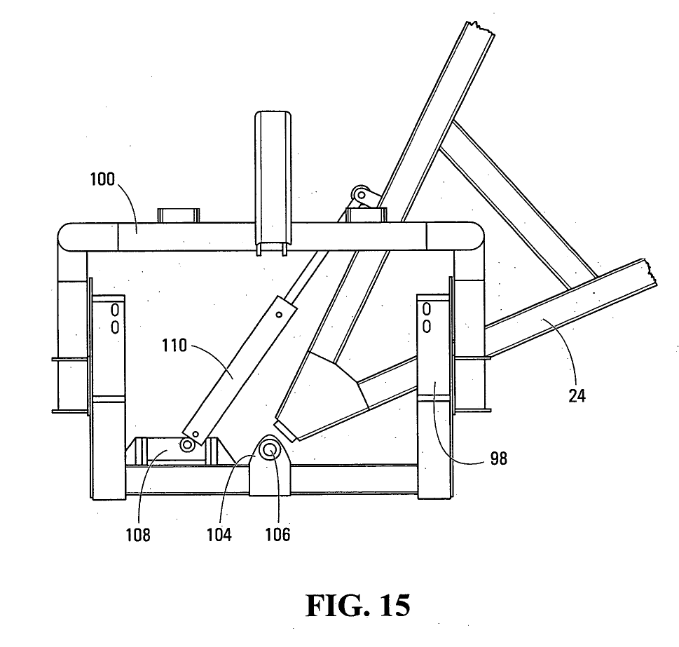

Referring now to FIG. 13, the support of the device 10 in accordance with an embodiment of the present invention is illustrated generally and identified by reference numeral 14. The support 14 includes a first frame 98 fastened to the vehicle 16 and a second frame 100 fastened to the first frame 98. The first frame 98 may be fastened to a front section of a chassis 102 of the vehicle 16 using bolted connections or other fastening means. As shown in FIGS. 14 and 15, the first frame 98 includes a first bracket 104 adapted to support a ball-and-socket joint (not shown) that is used to connect the truss assembly 24 of the transferring member 18 to the support 14. The ball-and-socket joint allows the transferring member 18 to freely pivot relative to the support 14 about any axis of rotation, thereby allowing the transferring member 18 to follow the roadway profile via wheel assemblies 34 and 74.

The first frame 98 further includes a second bracket 108 adapted to pivotally support a first end of an angular positioning actuator 110, a second end of which is pivotally connected to one side of the V-shaped truss assembly 24 of the transferring member 18 (as best seen in FIG. 15). In the embodiment shown, the angular positioning actuator 110 is a hydraulic cylinder although it will be apparent to those skilled in the art that other types of actuator may be used without departing from the spirit and scope of the invention. The angular positioning hydraulic cylinder 110 allows the transferring member 18 to be controllably rotated about the ball-and-socket joint of the support 14. In a non-limiting example of implementation, the angular positioning hydraulic cylinder 110 is operative to pivot the transferring member 18 about the ball-and-socket joint up to an angle of ±45° with respect to the longitudinal axis of the vehicle 16. As described in further detail herein below, the angular positioning hydraulic cylinder 110 is connected via a hydraulic control valve and line to the hydraulic panel that is part of the control system of the device 10.

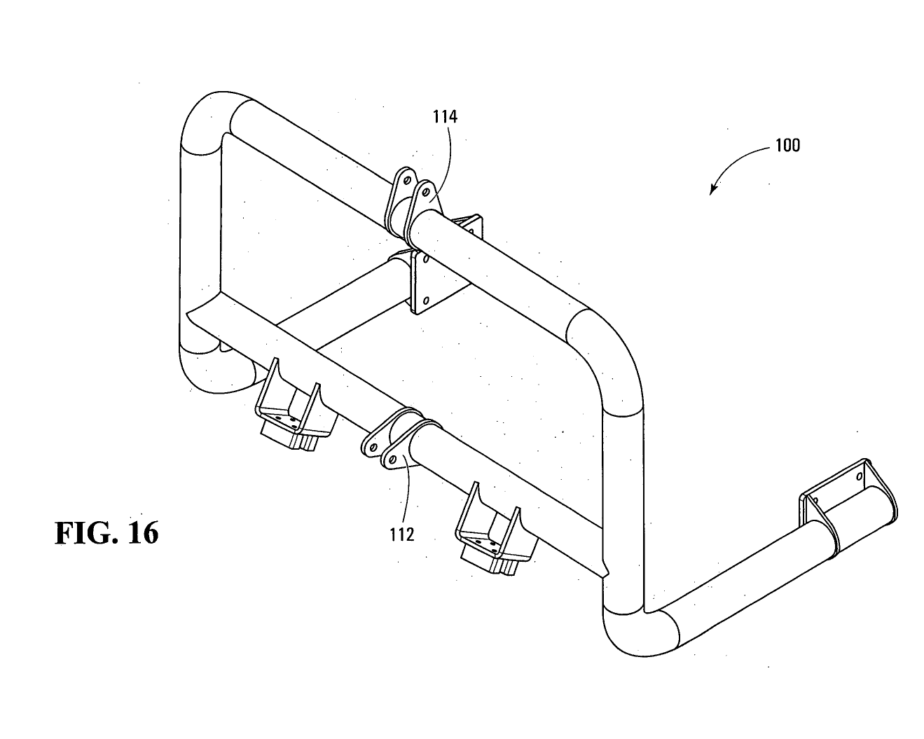

The second frame 100 of the support structure 14 is fastened to the first frame 98 using bolted connections. Referring to FIG. 16, the second frame 100 includes two generally horizontal members on which are respectively located a lower pivot bracket 112 and an upper pivot bracket 114. As best seen in FIG. 13, the lower pivot bracket 112 is adapted to pivotally support a first end of a vertical positioning actuator 116, the second end of which is secured to a link 118 pivotally connected to the upper pivot bracket 114. In the embodiment shown, the vertical positioning actuator 116 is a hydraulic cylinder although it will be apparent to those skilled in the art that other types of actuator may be used without departing from the spirit and scope of the invention. The vertical positioning hydraulic cylinder 116 allows the transferring member 18 to be controllably translated in a generally vertical direction in relation to the support 14. As described in further detail herein below, the vertical positioning hydraulic cylinder 116 is connected via a hydraulic control valve and line to the hydraulic panel that is part of the control system of the device 10.

For example, in order to raise the transferring member 18 in relation to the support 14, the vertical positioning hydraulic cylinder 116 is actuated to its full extension. By means of a chain or wire (not shown) linking the link 118 and the truss assembly 24, the relative upward movement of the link 118 causes the truss assembly 24, and thus the transferring member 18, to be raised.

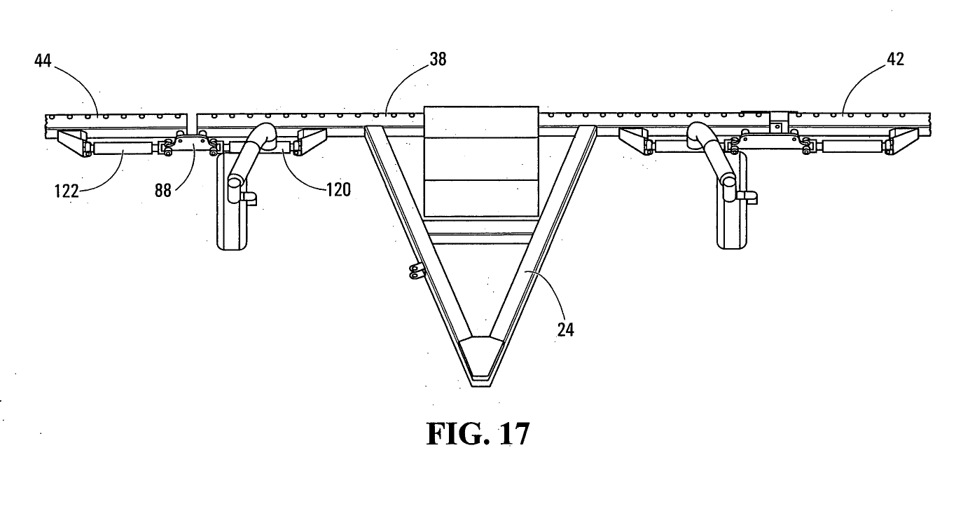

The transferring member 18 may also be folded in a compact configuration during a transport mode. Referring to FIG. 17, the transferring member 18 optionally includes a first folding actuator 120 having a first end pivotally connected to the left side of the central section 38, and a second end pivotally connected to the link 88 connecting the left arm 40 and the central section 38. A second folding actuator 122 has a first end pivotally connected to the link 88 and a second end connected to the left arm 40, and more specifically to the fourth leftmost section 44 of the left arm 40 in the embodiment shown. In the specific example of implementation shown, the first and second folding actuators 120 and 122 are hydraulic cylinders although it will be apparent to those skilled in the art that other types of actuator may be used without departing from the spirit and scope of the invention. As described below, the first and second folding hydraulic cylinders 120 and 122 are each connected via respective hydraulic control valves and lines to the hydraulic panel that is part of the control system of the device 10.

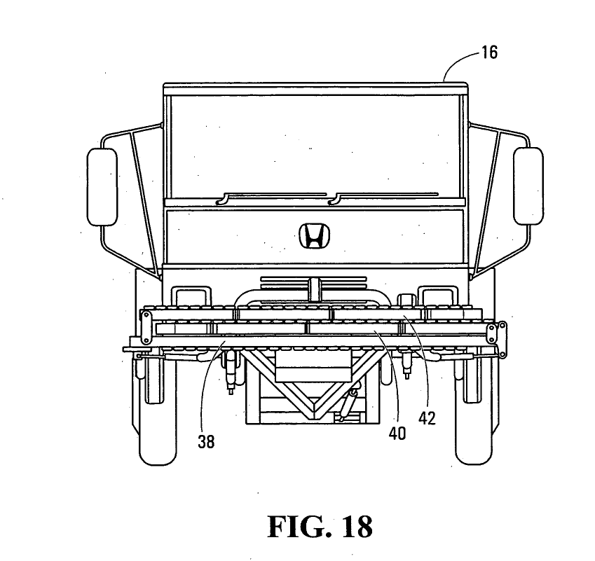

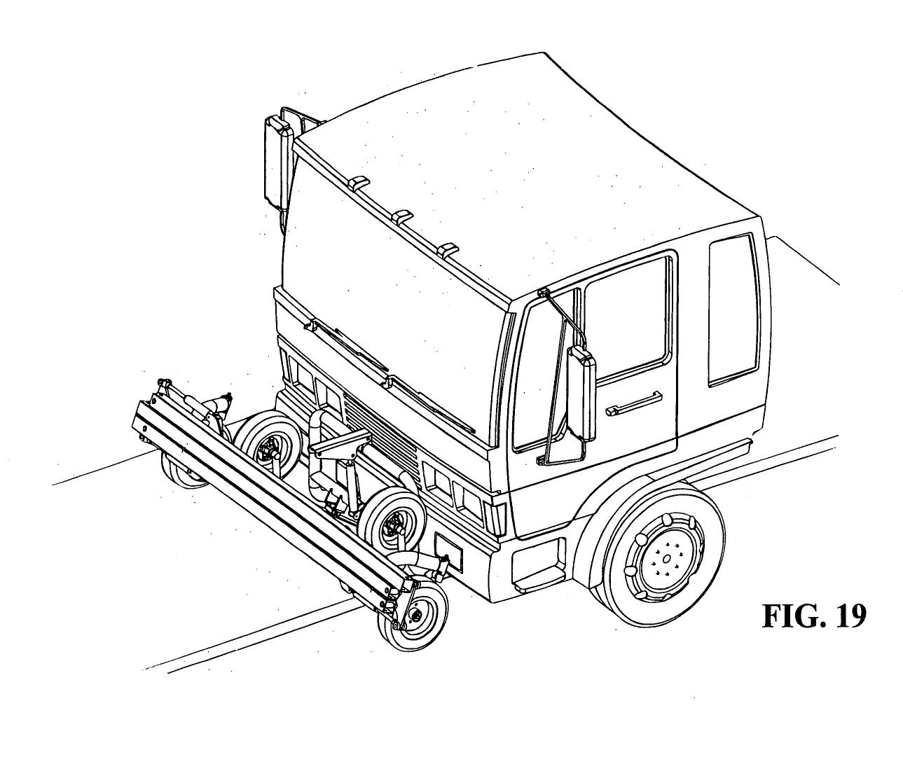

In order to achieve the compact configuration, the first folding hydraulic cylinder 120 is actuated to cause a 90° rotation of the link 88 about the transversely extending pin 28 of the central section 38, thereby rotating the left arm 40 by a first 90° angle. Simultaneously or subsequently, the second folding hydraulic cylinder 122 is actuated to cause a 90° rotation of the left arm 40 about its transversely extending pin 46, thereby rotating the left arm 40 by a second 90° angle. The total 180° rotation angle results in the left arm 40 being folded onto the central section 38. Furthermore, as can be seen in FIG. 17, two additional folding hydraulic cylinders are respectively disposed on the right side of the central section 38 and on the right arm 42 in order to fold the right arm 42 onto the left arm 40. FIGS. 18 and 19 shows the compact configuration of the transferring member 18 in the transport mode.

Although the above embodiment described a complete folding of the left arm 40 onto the central section 38 and of the right arm 42 onto the left arm 40, it will be appreciated that the reverse folding action (i.e. right arm 42 onto central section 38 and left arm 40 onto right arm 42) is also possible without detracting from the scope of the present invention. Moreover, it is to be understood that the complete folding of the respective sections of the left and right arms 40 and 42 using two 90° angle rotations was for purposes of example only. Accordingly, it will be appreciated that a partial folding of the sections of the arms 40 and 42 is possible using various actuator arrangements to impart various rotation angles in order to achieve a more compact configuration of the transferring member 18.

As mentioned herein above, the angular positioning hydraulic cylinder 110, the vertical positioning hydraulic cylinder 116, and the first and second folding hydraulic cylinders 120 and 122 are connected via respective hydraulic control valves and lines to a hydraulic panel that is part of a control system of the device 10. In a similar manner, the hydraulic cylinders (e.g., 76 in FIG. 4) allowing the end sections of the transferring member 18 to pivot in order to facilitate the engagement and release of the roadway marker 12 are also connected to the hydraulic panel in the control system. Optionally, various electrical components that may be used in connection with the device 10 may be connected via respective electric lines to an electrical circuit that is also part of the control system of the device.

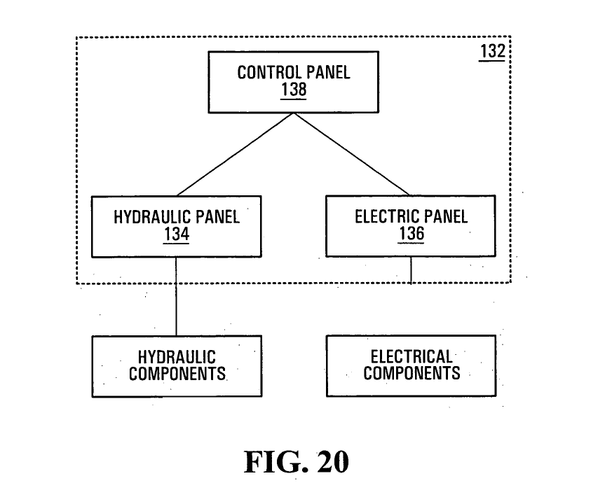

In FIG. 20, a control system for controlling the various above components of the device 10 is illustrated schematically and identified by reference numeral 132. The control system 132 includes a hydraulic panel 134, an electrical circuit 136, and a control panel 138 in communication with the hydraulic panel 134 and the electrical circuit 136. The control panel 138 includes a user interface adapted to allow an operator of the device 10 to enter control commands, and a processing unit in communication with the user interface and operative to generate control signals on the basis of the entered control commands. The hydraulic panel 134 includes a hydraulic circuit interacting with the above-listed hydraulic cylinders via their respective lines and valves in order to actuate the cylinders in response to commands entered at the user interface of the control panel 138 by the operator of the device 10. As well, the electrical circuit 136 includes appropriate circuitry to activate and control the any of the various electrical components of the device 10 in response to commands entered at the control panel 138. In a specific example of implementation, the hydraulic panel 134 and the electric circuit 136 are included in respective units that are mounted, for example, on the first frame 98 of the support 14.

The user interface of the control panel 138 may be located inside the vehicle 16 and may include command buttons and a monitor for managing the operation of the various components of the device 10. In a non-limiting example of implementation, the control panel 138 may include an appropriate number of command buttons for controlling (1) the angular positioning hydraulic cylinder 110 to rotate the transferring member 18 with respect to the longitudinal axis of the vehicle 16; (2) the vertical positioning cylinder 116 to raise or lower the transferring member 18; and (3) the folding hydraulic cylinders 120 and 122 to fold or unfold the left and right arms 40 and 42 of the transferring member 18. As well, the control panel 138 may include appropriate command buttons to control the any of the various electrical components of the device 10.

The above description of the embodiments should not be interpreted in a limiting manner since other variations, modifications and refinements are possible within the spirit and scope of the present invention. The scope of the invention is defined in the appended claims and their equivalents.

1. A roadway marker transferring device for a vehicle having a longitudinal axis, said roadway marker transferring device comprising:
(a) a support for mounting said device on the vehicle; and
(b) a transferring member connected to said support, said transferring member comprising a first end and a second end with a transferring section therebetween, said transferring section being at an oblique angle relative to the longitudinal axis of the vehicle;
wherein, upon movement of the vehicle, said first end engages the roadway marker at a first position on the roadway, said transferring section then engages and transfers the roadway marker towards said second end of said transferring member wherein the roadway marker is afterwards released at a second position on the roadway.

2. A device as defined in claim 1, wherein said transferring member is at an angle of 30° to 50° relative to the longitudinal axis of the vehicle.

3. A device as defined in claim 2, wherein said transferring section comprises a plurality of rollers for rotating and sliding the roadway marker as the marker is transferred towards said second end of said transferring member.

4. A device as defined in claim 3, wherein said first position corresponds to a first roadway lane and said second position corresponds to a second roadway lane such that traffic is transferred from one stream of traffic to another stream of traffic when the roadway marker is transferred from said first position to said second position.

5. A device as defined in claim 4, wherein said plurality of rollers are positioned on said transferring section such that at least one roller is in contact with the roadway marker as the marker is transferred towards said second end of said transferring member.

6. A device as defined in claim 5, wherein said transferring member comprises at least one wheel adapted to contact the roadway.

7. A device as defined in claim 6, wherein said transferring section comprises a plurality of pivotally connected sections.

8. A device as defined in claim 7, wherein said plurality of pivotally connected sections are connected to each other by a pivot having two separate pins.

9. A device as defined in claim 8, wherein said transferring member comprises a mechanism to maintain said plurality of pivotally connected sections in a predetermined configuration, said mechanism being responsive to a predetermined force applied on a first section of said plurality of pivotally connected sections for allowing said first section to pivot in relation to a second section of said plurality of pivotally connected sections and for allowing said first section to pivot back to the predetermined configuration when the predetermined force is no longer applied.

10. A device as defined in claim 9, wherein said mechanism comprises a connector linking said plurality of pivotally connected sections, a hydraulic cylinder connected to said connector, and a hydraulic accumulator connected to said hydraulic cylinder.

11. A device as defined in claim 10, wherein said plurality of pivotally connected sections comprises a central section, a main left section pivotally connected to said central section, and a main right section pivotally connected to said central section.

12. A device as defined in claim 11, wherein said main left and main right sections each respectively comprise four pivotally connected sections.

13. A device as defined in claim 3, wherein said transferring member comprises a mechanism for folding said transferring member in a compact configuration.

14. A device as defined in claim 9, wherein said mechanism to maintain said plurality of pivotally connected sections in a predetermined configuration is a first mechanism, wherein said transferring member comprises a second mechanism for folding said transferring member in a compact configuration.

15. A device as defined in claim 14, wherein said second mechanism is adapted to fold at least in part said first section of said plurality of pivotally connected sections on said second section of said plurality of pivotally connected sections.

16. A device as defined in claim 15, wherein said second mechanism comprises an actuator connected to said first section and a link coupled to said second section and to said actuator, said actuator and said link cooperating to fold at least in part said first section on said second section.

17. A device as defined in claim 16, wherein said actuator is a hydraulic cylinder.

18. A device as defined in claim 3, wherein said transferring member is movably connected to said support.

19. A device as defined in claim 18, further comprising a mechanism connected to said support and to said transferring member, said mechanism being operative to controllably move said transferring member in relation to said support.

20. A device as defined in claim 19, wherein said mechanism is operative to controllably rotate said transferring member in relation to said support.

21. A device as defined in claim 20, wherein said mechanism is operative to controllably raise or lower said transferring member in relation to said support.

22. A device as defined in claim 3, further comprising a control system comprising:
a user interface adapted to allow a user to enter control commands;
a processing unit in communication with said user interface, said processing unit being operative to generate control signals on the basis of the entered control commands; and
a control circuit connected to said transferring member, said control circuit being responsive to said generated control signals for controlling said transferring member.

23. A vehicle comprising a roadway marker transferring device as defined in claim 3.
